(19) United States
(12) Patent Application Publication
(10) Pub. No.: US 2026/0194119 A1
(43) Pub. Date: Jul. 9, 2026

(54) COMPACT DUAL BOOST VALVE SYSTEM FOR A HYDRAULIC DAMPER

(71) Applicant: Fox Factory, Inc., Duluth, GA (US)

(72) Inventor: Tyler Eston, Solon, OH (US)

(21) Appl. No.: 19/008,822

(22) Filed: Jan. 3, 2025

(51) Int. Cl. F16F 9/46; F16F 9/18

(52) U.S. Cl. CPC F16F 9/469; F16F 9/187; F16F 9/461

(57) ABSTRACT

A compact dual boost valve system for a hydraulic damper is provided. The system includes a pilot stage comprising a proportional pressure relief poppet valve coupled within a damper rod of the hydraulic damper, a compression main stage including a compression damping boost valve, and a rebound main stage including a rebound damping boost valve. The poppet valve may be in fluid communication with the compression damping boost valve assembly and the rebound damping boost valve assembly. During a compression event, the poppet valve is biased in a closed position to equalize pressure in the compression damping boost valve assembly and the rebound damping boost valve assembly with an upstream damper pressure to generate high levels of hydraulic pressure across the main piston until a blow-off pressure of the poppet valve is reached and the poppet valve opens generating a pressure drop across an inlet orifice and a poppet orifice.

### BACKGROUND OF THE INVENTION

### Technical Field

This invention relates generally to a dual boost valve system for a hydraulic damper and more particularly to a compact dual boost valve system for a hydraulic damper.

### State of the Art

The use of dampers on vehicles is commonplace. Traditional dampers feature a hydraulic main piston with one deflecting disc shim stack for compression damping and another deflecting disc shim stack for rebound damping. This main piston and the deflecting disc shim stacks are attached to a rod. These components are passive and not adjustable during operation. Conventional mechanisms exist that allow for electronic control of damping force to provide active adjustment of the damping force during operation. These conventional mechanisms tend to take up considerable space when installed onto the damper rod. These conventional mechanisms also tend to have adjustment for only one flow direction (i.e., compression or rebound), and those that have adjustment for both directions tend to be proportionally related. Most conventional systems also are difficult to calibrate and tune, and the systems require costly and complex components for each individual chassis application.

Accordingly, there is a need for an improved compact dual boost valve system for a hydraulic damper.

### SUMMARY OF THE INVENTION

An embodiment includes a compact dual boost valve system for a hydraulic damper comprising: a pilot stage comprising a proportional pressure relief poppet valve coupled within a damper rod of the hydraulic damper; a compression main stage comprising a compression damping boost valve coupled on a compression side of a main piston of the hydraulic damper; and a rebound main stage comprising a rebound damping boost valve coupled on a rebound side of a main piston of the hydraulic damper, the poppet valve in fluid communication with the compression damping boost valve assembly and the rebound damping boost valve assembly, wherein during a compression event with the poppet valve biased in a closed position: the poppet valve operates to equalize pressure in the compression damping boost valve assembly and the rebound damping boost valve assembly with an upstream damper pressure to generate high levels of hydraulic pressure across the main piston until a blow-off pressure of the poppet valve is reached; and opening the poppet valve with the high levels of hydraulic pressure and generating a pressure drop across an inlet orifice and a poppet orifice in response to hydraulic flow through the poppet valve after the poppet valve opens.

Another embodiment includes a compact dual boost valve system for a hydraulic damper comprising: a piston assembly of the hydraulic damper, the piston assembly comprising: a damper rod; a boost post coupled to the damper rod on a first end of the boost post, the boost post comprising a central chamber extending along an axis of the boost post with an inlet orifice located a second end of the boost post and extending into the central chamber; a main piston coupled around the boost post; a compression deflecting disc shim stack coupled around the boost post on a compression side of the main piston for compression damping; and a rebound deflecting disc shim stack coupled around the boost post on a rebound side of the main piston for rebound damping; a pilot stage comprising a proportional pressure relief poppet valve coupled within a damper rod of the hydraulic damper, the poppet valve comprising: a poppet coupled to an armature retained within a cartridge, the poppet and the armature guided by a bearing surface of the cartridge; a poppet orifice located at the second end of the boost post and extending into the central chamber, wherein the poppet is biased against the poppet orifice by a poppet spring; and a bobbin carrying a solenoid coil coupled around the cartridge, the solenoid coil operating between a zero-power state and a 100% power state, wherein a powered state above the zero-power state reduces an amount of force the poppet applies to the poppet orifice, wherein the reduction in the amount of force increases until sufficient power is applied to overcome a spring force of the poppet valve reaching the 100% power state; a compression main stage comprising a compression damping boost valve assembly, the compression damping boost valve assembly comprising: a compression boost valve coupled around the boost post on a compression side of a main piston of the hydraulic damper, wherein the compression boost valve is biased against the compression deflecting disc shim stack by a boost valve compression spring; and a compression boost valve chamber coupled to the central chamber by a compression feed orifice; and a rebound main stage comprising a rebound damping boost valve assembly, the rebound damping boost valve assembly comprising: a rebound boost valve coupled around a boost nut, the boost nut coupled to the second end of the boost post, wherein the rebound boost valve is biased against the rebound deflecting disc shim stack by a boost valve rebound spring; and a rebound boost valve chamber fluidly coupled to the central chamber by a boost nut rebound feed orifice extending through the boost nut that interfaces with a boost post rebound feed orifice extending from the central chamber, wherein during a compression event at the zero-power state: the poppet is biased against the poppet orifice; the poppet valve operates to equalize pressure in the compression boost valve chamber and the rebound boost valve chamber with an upstream damper pressure to generate high levels of hydraulic pressure across the main piston until a blow-off pressure of the poppet valve is reached; and opening the poppet with the high levels of hydraulic pressure and generating a pressure drop across the inlet orifice and the poppet orifice in response to hydraulic flow through the poppet valve after the poppet valve opens.

Yet another embodiment includes a method of boosting damping a hydraulic damper, the method comprising: providing a compact dual boost valve system coupled to a piston assembly of the hydraulic damper, the compact dual boost valve system comprising: a pilot stage comprising a proportional pressure relief poppet valve coupled within a damper rod of the hydraulic damper, the poppet valve comprising: a poppet coupled to an armature retained within a cartridge, the poppet and the armature guided by a bearing surface of the cartridge; a poppet orifice located at the second end of the boost post and extending into the central chamber, wherein the poppet is biased against a poppet orifice by a poppet spring; and a bobbin carrying a solenoid coil coupled around the cartridge, the solenoid coil operating between a zero-power state and a 100% power state, wherein a powered state above the zero-power state reduces an amount of force the poppet applies to the poppet orifice, wherein the reduction in the amount of force increases until sufficient power is applied to overcome a spring force of the poppet valve reaching the 100% power state; a compression main stage comprising a compression damping boost valve coupled on a compression side of a main piston of the hydraulic damper; and a rebound main stage comprising a rebound damping boost valve coupled on a rebound side of a main piston of the hydraulic damper, the poppet valve in fluid communication with the compression damping boost valve assembly and the rebound damping boost valve assembly; performing a compression event in the zero-powered state during operation of the hydraulic damper with the poppet biased against the poppet orifice; equalizing pressure in the compression damping boost valve assembly and the rebound damping boost valve assembly with an upstream damper pressure in response to the poppet valve in the closed position to generate high levels of hydraulic pressure across the main piston until a blow-off pressure of the poppet valve is reached; and opening the poppet valve with the high levels of hydraulic pressure and generating a pressure drop across an inlet orifice and the poppet orifice in response to hydraulic flow through the poppet valve after the poppet moves away from the poppet orifice.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a piston assembly of a hydraulic damper according to an embodiment;

FIG. 2 is a perspective section view of a piston assembly of a hydraulic damper according to an embodiment;

FIG. 3 is a section view of a piston assembly of a hydraulic damper according to an embodiment;

FIG. 4 is a section view of a piston assembly of a hydraulic damper according to an embodiment;

FIG. 5 is a section view of a proportional pressure relief poppet valve of a piston assembly of a hydraulic damper according to an embodiment;

FIG. 6 is a section view of a rebound boost valve assembly of a piston assembly of a hydraulic damper according to an embodiment;

FIG. 7A is a section view of a compression boost valve assembly of a piston assembly of a hydraulic damper according to an embodiment;

FIG. 7B is another section view of a compression boost valve assembly of a piston assembly of a hydraulic damper according to an embodiment;

FIG. 8 is a perspective section view of a piston assembly of a hydraulic damper according to an embodiment;

FIG. 9 is a perspective section view of a piston assembly of a hydraulic damper according to an embodiment;

FIG. 10 is a perspective section view of a proportional pressure relief poppet valve of a piston assembly of a hydraulic damper according to an embodiment;

FIG. 11 is a perspective section view of a compression boost valve assembly of a piston assembly of a hydraulic damper according to an embodiment;

FIG. 12 is a perspective section view of a rebound boost valve assembly of a piston assembly of a hydraulic damper according to an embodiment; and

FIG. 13 are a plurality of graphs depicting damping in compression and rebound of a piston assembly of a hydraulic damper according to an embodiment.

### DETAILED DESCRIPTION OF EMBODIMENTS OF THE INVENTION

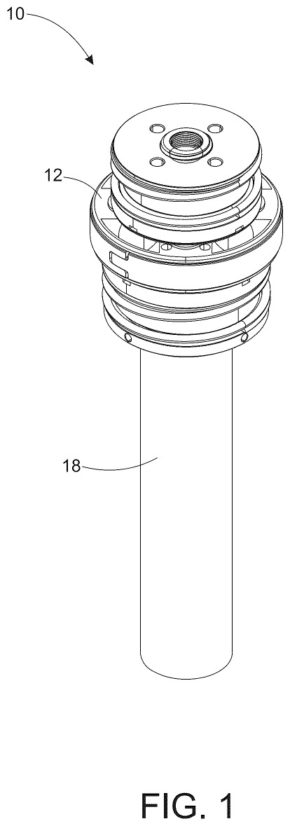

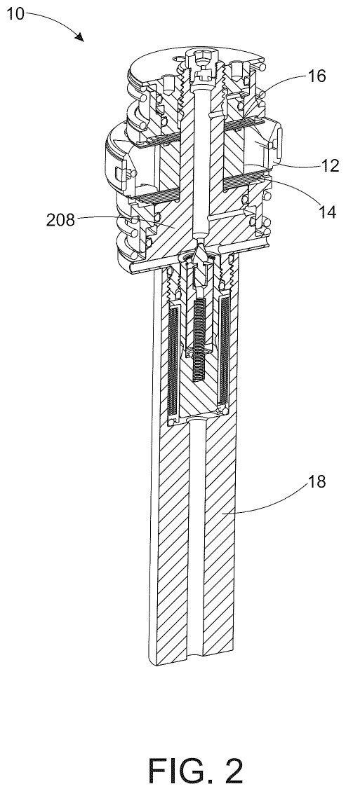

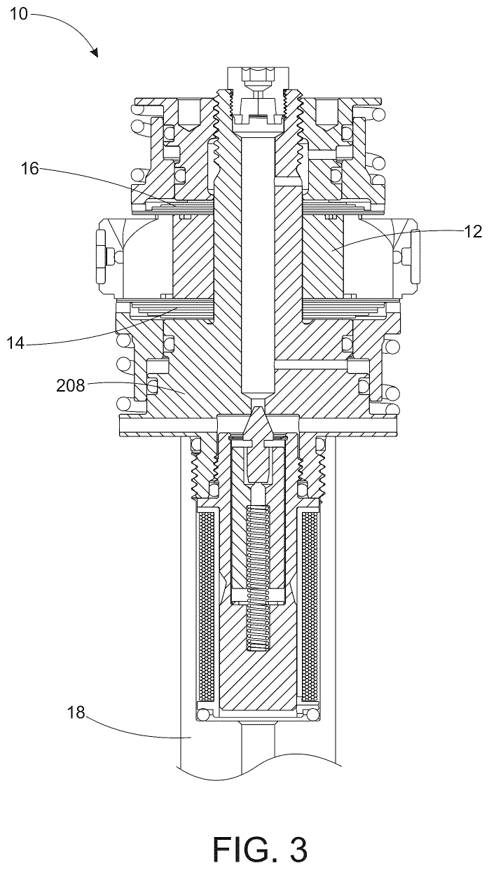

As discussed above, embodiments of the present invention relate to compact dual boost valve system for a hydraulic damper. As shown in FIG. 1-3, the hydraulic damper includes a piston assembly 10 that comprises a main piston 12 with a compression deflecting disc shim stack 14 for compression damping and a rebound deflecting disc shim stack 16 for rebound damping, wherein the main piston 12, the compression deflecting disc shim stack 14 and the rebound deflecting disc shim stack 16 are all coupled to a damper rod 18. In embodiments, the main piston 12, the compression deflecting disc shim stack 14 and the rebound deflecting disc shim stack 16 are all coupled around a boost post 208, and the boost post 208 is coupled to the damper rod 18. In at least this way, the main piston 12, the compression deflecting disc shim stack 14 and the rebound deflecting disc shim stack 16 are coupled to the damper rod 18.

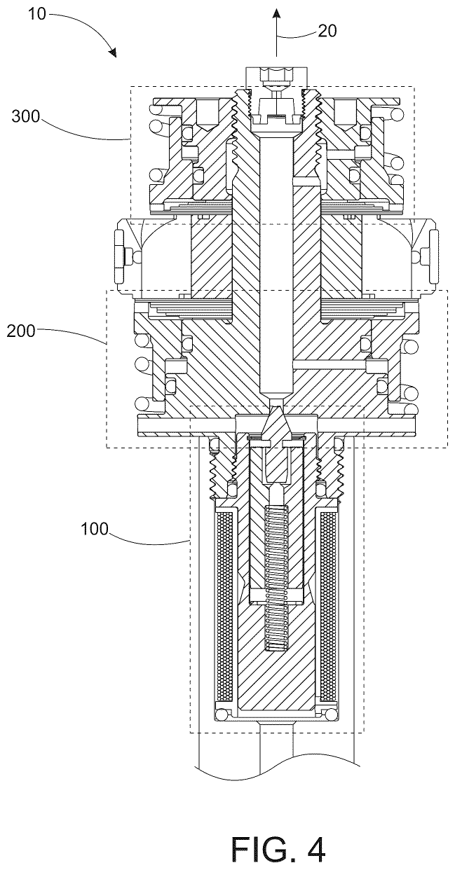

Referring further to FIG. 4, embodiment of the present invention utilizes a proportional pressure relief poppet valve 100 as a pilot stage, which is retained and operated within the damper rod 18 to hydraulically actuate two separate main stage boost valves. These two separate main stage boost valves comprise a compression damping boost valve 200 and a rebound damping boost valve 300, which provide damping support to the passive components. Due to the inherent difference in characteristics between forward and reverse flow through the poppet valve 100, semi-independent and inversely related control of compression damping and rebound damping is achieved. Embodiments include a limited number of interchangeable parts that allows for easy calibration and tunability for various applications. In these embodiments, hydraulic damping is adjustable with infinite resolution, and the effects of adjustment on compression damping and rebound damping are semi-independent, inversely-related, and controlled with one single pilot stage.

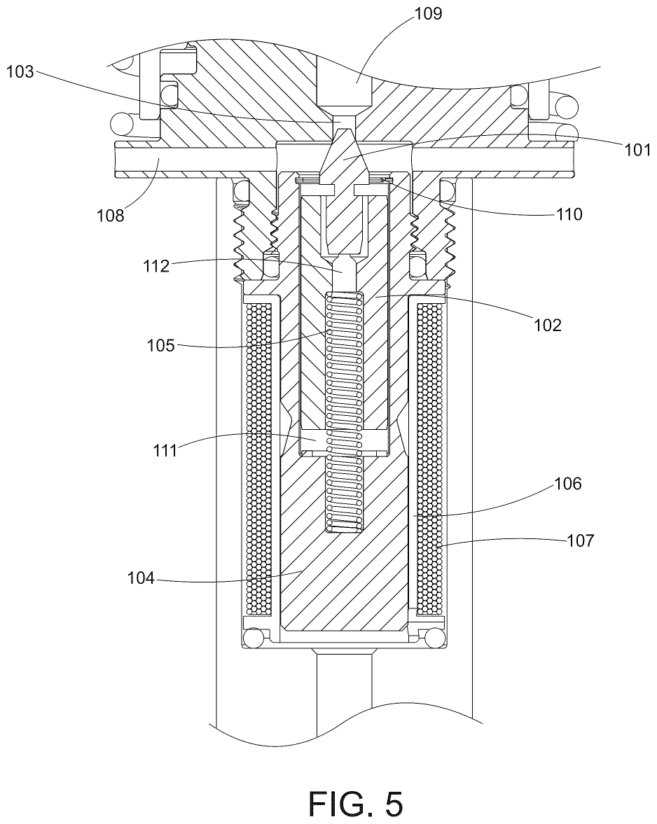

As shown in FIG. 5, the poppet valve 100 is a proportional pressure relief poppet valve 100 acting as the pilot stage and is retained within the damper rod 18. The poppet valve 100 comprises an assembly of a poppet 101 coupled to an armature 102 retained within a cartridge 104. The assembly of the poppet 101 and the armature 102 is guided in its movement by a bearing surface 111 and the poppet 101 seated against the poppet orifice 103 in response to a poppet spring 105 biasing the poppet 101 in a direction toward the poppet orifice 103. The armature 102 comprises an internal diameter pass-through 112 that is sized to create hydraulic damping of armature motion. During service and assembly, the assembly of the poppet 101 and the armature 102 and the bearing surface 111 may be retained within the cartridge 104 by a retaining ring 110. Surrounding the cartridge 104 is a bobbin 106 which carries a solenoid coil 107. The solenoid coil 107 operates between a zero-power state and a 100% power state. The zero-power state is when the solenoid coil 107 has no current flowing through it and therefore cannot operate to move the armature 102 and therefore the poppet 101 away from poppet orifice 103. The 100% power state is when the maximum current is flowing through the solenoid coil 107 to overcome a spring force of the poppet valve 100 that then moves the armature 102 and therefore the poppet 101 to a maximum distance away from the poppet orifice 103. Various percentages of power may be utilized as a way of tuning the damping of the poppet valve 100.

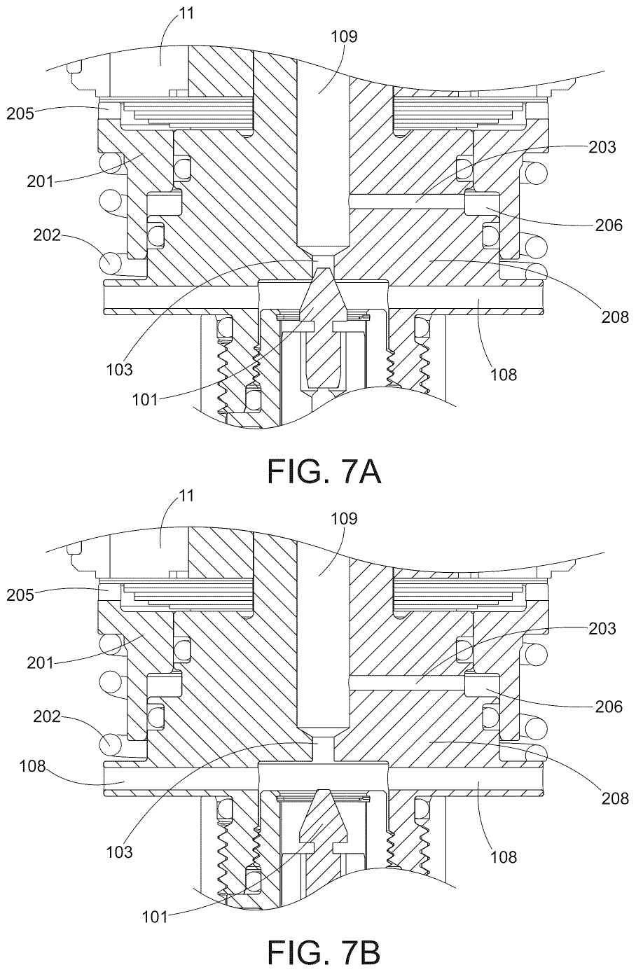

As shown in FIGS. 7A-7B, the compression boost valve assembly 200 acts as the compression main stage and comprises a compression boost valve 201 coupled around the boost post 208. The compression boost valve 201 is biased against the passive compression deflecting disc shim stack 14 by a boost valve compression spring 202. The compression boost valve 201 further comprises a compression boost valve chamber 206 that is fluidly coupled with a compression feed orifice 203 extending from a central chamber 109 located along an axis of the boost post 208.

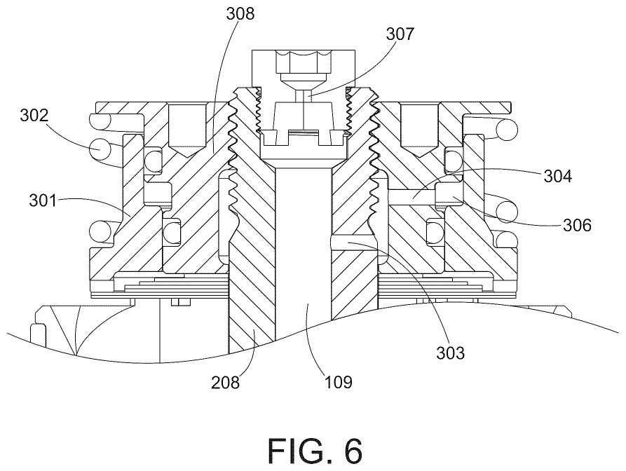

As shown in FIG. 6, the rebound boost valve assembly 300 acts as the rebound main stage and comprises a rebound boost valve 301 coupled around the boost nut 308. The rebound boost valve 301 is biased against the passive rebound deflecting disc shim stack 16 by a boost valve rebound spring 302. The boost nut 308 is coupled to an end of the boost post 208 and operates to retain the components of the rebound boost valve assembly 300, the main piston 12, the compression deflecting disc shim stack 14, the rebound deflecting disc shim stack 16 and the compression boost valve assembly 200 coupled around the boost post 208. The rebound boost valve 301 further comprises a rebound boost valve chamber 306 that is fluidly coupled with a boost nut rebound feed orifice 304 extending through the boost nut 308 that interfaces with a boost post rebound feed orifice 303 extending from the central chamber 109 of the boost post 208. The boost nut rebound feed orifice 304 interfaces with the boost post rebound feed orifice 303 at boost nut chamber 309, wherein the boost nut chamber 309 allows for unrestricted rotation of components and axial flexibility to compensate for differences in the rebound deflecting disc shim stack 16 tuning by providing a means of fluid coupling between the boost nut rebound feed orifice 304 and the boost post rebound feed orifice 303 without the boost nut rebound feed orifice 304 and the boost post rebound feed orifice 303 being aligned. Further, an inlet orifice 307 may be coupled to an end of the boost post 208 and allows hydraulic fluid to flow into and out of the central chamber 109.

During operation, rod velocity, rod acceleration, electrical control signal to the poppet valve 100, and sizes of the two control orifices, which include poppet orifice 103 and inlet orifice 307, determine the pressure communicated simultaneously to both main stage boost valves via the central chamber 109.

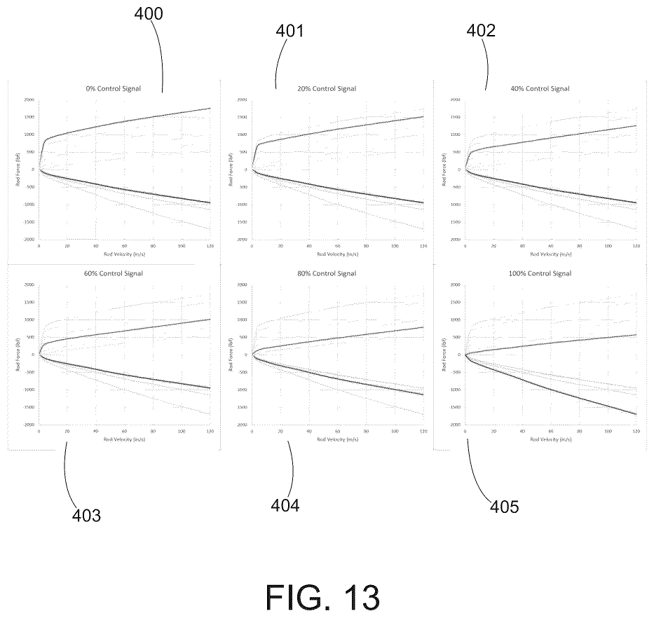

Referring to FIGS. 4-7B, a compression event in a zero-power state is depicted, wherein the compression event occurs as the piston assembly 10 moves in a direction shown by arrow 20. In this zero-power state compression event, the poppet valve 100 will build pressure within the central chamber 109, which is equalized to the compression boost valve chamber 206 via the compression feed orifice 203 and rebound boost valve chamber 306 via the rebound feed orifices 303 and 304. Without hydraulic flow through the poppet valve 100, the pressure in both boost valves 200 and 300 is equal to upstream damper pressure, and both boost valves 200 and 300 generate a force which acts against the passive deflecting disc shim stacks 14 and 16, respectively. Accordingly, during a compression event, only the compression boost valve 200 has a direct effect on damping performance. This compression boost valve 200 is what generates high levels of hydraulic pressure across the main piston 12, thereby restricting the flexing of the compression deflecting disc shim stack 14 and inhibiting hydraulic flow through compression ports 11 of the main piston 12, until the blow-off pressure of the poppet valve 100 is reached. When this occurs the poppet 101 moves from being seated on the poppet orifice 103 as shown in FIG. 7A to a position unseated or away from the poppet orifice 103, as shown in FIG. 7B. When this occurs, pressure drops are then generated across both the inlet orifice 307 and poppet orifice 103 as a result of hydraulic flow through the central chamber 109 and out of exit orifice 108 of the poppet valve 100, and the central chamber 109 no longer builds pressure that is equal to upstream damper pressure and the main piston 12 with the compression deflecting disc shim stack 14 operates with boost valve pressure that is now lower than upstream damper pressure, as function of the pressure drops across both the inlet orifice 307 and poppet orifice 103. This creates the digressive shape of the compression damping curves at higher rod velocities as shown in graph 400 of FIG. 13.

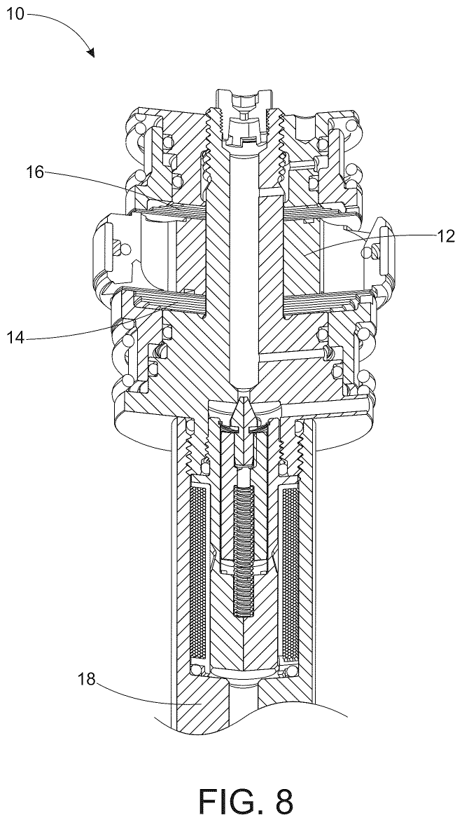

Referring to FIG. 8, during a rebound event in the zero-power state, the poppet valve will shuttle closed. During a rebound event, only the rebound boost valve 300 has a direct effect on damping performance. The central chamber 109 pressure will be equal to downstream damper pressure. The result is no increased pressurization of either main stage boost valve 200 or 300, and therefore no hydraulic pressure force generated against either deflecting disc shim stack 14 or 16, respectively. Accordingly, in a zero-power state, the main piston 12 with the rebound deflecting disc shim stack 16 operates without the added hydraulic pressure and damping is controlled only by the rebound deflecting disc shim stack 16 operates to allow fluid flow through rebound ports 13 of the main piston 12 without the added hydraulic pressure and only the added pressure of the force applied by the boost valve rebound spring 302. This creates the shape of the rebound damping curves at higher rod velocities as shown in graph 400 of FIG. 13.

As electrical signal power is increased to the solenoid coil 107, the blow-off pressure of the poppet valve 100 will decrease, creating the effect of proportional, adjustable control of compression damping. Rebound damping will continue to be unaffected until the magnetic force generated from the solenoid coil 107 is balanced against the poppet spring 105, resulting in zero cracking pressure of the poppet 101. Further electrical signal power will cause the poppet valve 100 to retract without any pressure needed. The condition now exists where during a rebound event, the central chamber 109 will experience hydraulic flow, and therefore a pressure higher than downstream pressure as a result of pressure drops across both control orifices 307 and 103. This pressure does energize both main stage boost valves 200 and 300 and generates a force which acts against the passive deflecting disc shim stacks 14 and 16, respectively. This solenoid coil 107 operating to retract the poppet valve 100 is what generates progressively higher levels of pressure across the main piston 12 during a rebound event as the poppet 101 continues to be further retracted away from the poppet orifice 103 with increased electrical signal power. Referring to FIG. 13 the effect of an electrical signal power to the solenoid coil 107 is depicted. As examples only, each graph depicted are at particular percentages of electrical signal power and the blue curve shows the compression damping and the red curve shows the rebound damping. Graph 400 is a zero-power state, graph 401 is a 20% power state, graph 402 is a 40% power state, graph 403 is a 60% power state, graph 404 is an 80% power state, and graph 405 is a 100% power state.

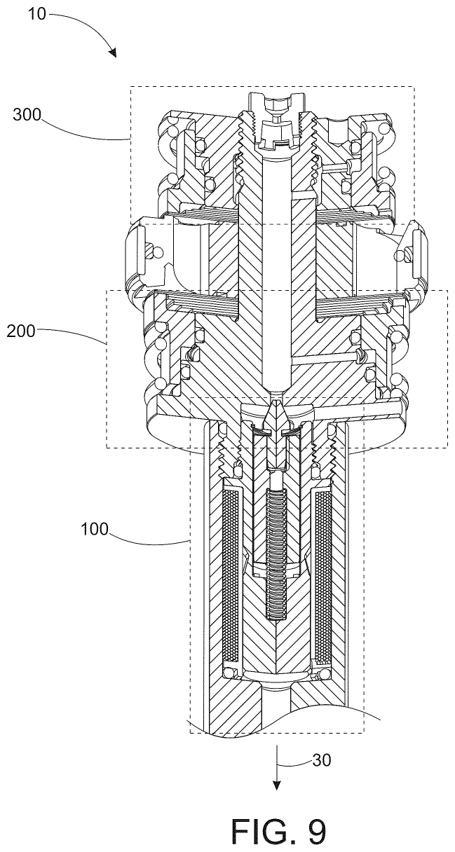

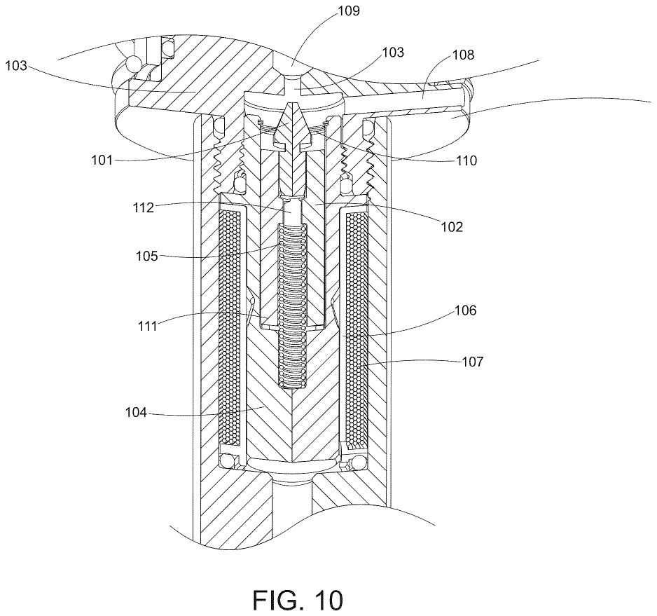

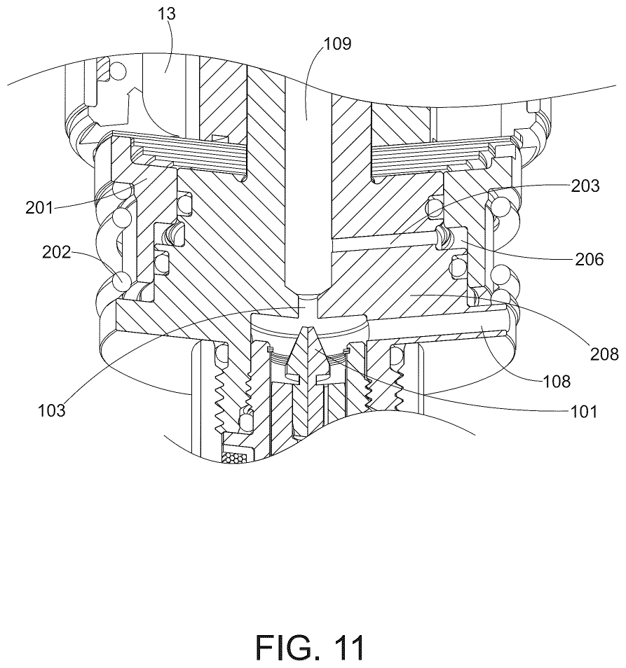

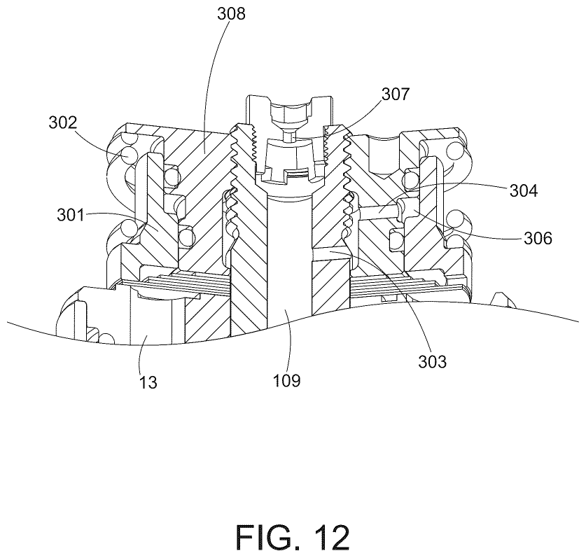

A rebound event at a 100% power state is depicted in FIGS. 9-12, wherein the rebound event occurs as the piston assembly 10 moves in a direction shown by arrow 30. In this 100% power state rebound event, the poppet valve 100 will be fully open (the poppet 101 moved as far away from the poppet orifice 103 as defined by the size of the cartridge 104) to allow hydraulic flow into the central chamber 109 to build pressure within the central chamber 109. This pressure in the central chamber 109 is equalized to the compression boost valve chamber 206 via the compression feed orifice 203 and rebound boost valve chamber 306 via the rebound feed orifices 303 and 304. The pressure in both boost valves 200 and 300 is higher than downstream pressure as a result of pressure drops across both control orifices 307 and 103, and both boost valves 200 and 300 generate a force which acts against the passive deflecting disc shim stacks 14 and 16, respectively. Accordingly, during a rebound event, only the rebound boost valve 300 has a direct effect on damping performance. This rebound boost valve 300 is what generates high levels of hydraulic pressure across the main piston 12, thereby restricting the flexing of the rebound deflecting disc shim stack 16 and inhibiting hydraulic flow through rebound ports 13 of the main piston 12, until a pressure in the rebound ports 13 reaches a pressure higher than the combined force of the rebound deflecting disc shim stack 16, the pressure of the rebound boost valve 300 and the force of the rebound boost valve spring 302 to allow hydraulic flow to move through the rebound ports 13. This creates the change in gain of the rebound damping curves at higher rod velocities as shown in graph 405 of FIG. 13.

It will be understood that the inlet orifice 307 and poppet orifice 103 are dependently sized to control poppet 101 blow-off pressure and relative gain of the boost valve assemblies 200 and 300. Accordingly, the ratio of the inlet orifice 307 to the poppet orifice 103 is important to affect the damping rates and is why these orifices are control orifices.

Referring again to FIG. 13, maximum compression damping is therefore generated during the zero-power state, as shown in graph 400, and features proportional pressure relief adjustment with increased electrical signal power as shown in graphs 401-405. Maximum rebound damping is generated during the 100% power state as shown in graph 405 and features proportional gain adjustment with decreased electrical signal power until the pressure relief poppet is closed against the poppet orifice via poppet spring force as shown in graphs 404-400.

It will also be understood that while embodiments shown and described above depict a zero-power state with the poppet valve 100 in a closed position and a 100% power state with the poppet valve 100 in a fully opened position, embodiments may employ the inverse where a zero-power state results in the poppet valve 100 in a fully opened position and a 100% power state results in the poppet valve in a closed position. In either configuration, hydraulic damping is adjustable with infinite resolution, and the effects of adjustment on compression damping and rebound damping are semi-independent, inversely-related, and controlled with one single pilot stage.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A compact dual boost valve system for a hydraulic damper comprising:
a pilot stage comprising a proportional pressure relief poppet valve coupled within a damper rod of the hydraulic damper;
a compression main stage comprising a compression damping boost valve coupled on a compression side of a main piston of the hydraulic damper; and
a rebound main stage comprising a rebound damping boost valve coupled on a rebound side of a main piston of the hydraulic damper, the poppet valve in fluid communication with the compression damping boost valve assembly and the rebound damping boost valve assembly, wherein during a compression event with the poppet valve biased in a closed position:
the poppet valve operates to equalize pressure in the compression damping boost valve assembly and the rebound damping boost valve assembly with an upstream damper pressure to generate high levels of hydraulic pressure across the main piston until a blow-off pressure of the poppet valve is reached; and
opening the poppet valve with the high levels of hydraulic pressure and generating a pressure drop across an inlet orifice and a poppet orifice in response to hydraulic flow through the poppet valve after the poppet valve opens.

2. The system of claim 1, further comprising a piston assembly of the hydraulic damper, the piston assembly comprising:
a damper rod;
a boost post coupled to the damper rod on a first end of the boost post, the boost post comprising a central chamber extending along an axis of the boost post with an inlet orifice located a second end of the boost post and extending into the central chamber;
a main piston coupled around the boost post;
a compression deflecting disc shim stack coupled around the boost post on a compression side of the main piston for compression damping; and
a rebound deflecting disc shim stack coupled around the boost post on a rebound side of the main piston for rebound damping.

3. The system of claim 2, wherein the poppet valve comprises:
a poppet coupled to an armature retained within a cartridge, the poppet and the armature guided by a bearing surface of the cartridge;
a poppet orifice located at the second end of the boost post and extending into the central chamber, wherein the poppet is biased against the poppet orifice by a poppet spring; and
a bobbin carrying a solenoid coil coupled around the cartridge, the solenoid coil operating between a zero-power state and a 100% power state, wherein a powered state above the zero-power state reduces an amount of force the poppet applies to the poppet orifice, wherein the reduction in the amount of force increases until sufficient power is applied to overcome a spring force of the poppet valve reaching the 100% power state.

4. The system of claim 3, wherein the compression damping boost valve assembly comprises:
a compression boost valve coupled around the boost post on a compression side of a main piston of the hydraulic damper, wherein the compression boost valve is biased against the compression deflecting disc shim stack by a boost valve compression spring; and
a compression boost valve chamber coupled to the central chamber by a compression feed orifice.

5. The system of claim 4, wherein the rebound damping boost valve assembly comprising:
a rebound boost valve coupled around a boost nut, the boost nut coupled to the second end of the boost post, wherein the rebound boost valve is biased against the rebound deflecting disc shim stack by a boost valve rebound spring; and
a rebound boost valve chamber fluidly coupled to the central chamber by a boost nut rebound feed orifice extending through the boost nut that interfaces with a boost post rebound feed orifice extending from the central chamber.

6. The system of claim 5, wherein the boost nut coupled to the first end of the boost post operates to retain the rebound boost valve assembly, the main piston, the compression deflecting disc shim stack, the rebound deflecting disc shim stack and the compression boost valve assembly coupled around the boost post.

7. The system of claim 6, wherein the boost nut rebound feed orifice interfaces with the boost post rebound feed orifice at boost nut chamber, wherein the boost nut chamber allows for unrestricted rotation of components of the rebound boost valve assembly and axial flexibility to compensate for differences in the rebound deflecting disc shim stack tuning by providing a means of a fluid coupling between the boost nut rebound feed orifice and the boost post rebound feed orifice without the boost nut rebound feed orifice and the boost post rebound feed orifice being aligned.

8. The system of claim 6, wherein rod velocity, rod acceleration, electrical control signal to the solenoid coil of the poppet valve, and sizes of the inlet orifice and the poppet orifice determine the pressure communicated simultaneously to both the compression boost valve assembly and the rebound boost vale assembly through the central chamber.

9. The system of claim 6, wherein during a rebound event in the zero-power state:
the poppet valve moves to the closed position with the poppet biased against the poppet orifice; and
the central chamber pressure is equal to downstream damper pressure resulting in no increased pressurization of either the compression boost valve chamber or the rebound boost valve chamber, and no hydraulic pressure force generated against either the compression deflecting disc shim stack or the rebound deflecting disc shim stack.

10. The system of claim 6, wherein during a rebound event in the 100% power state:
the poppet valve moves to a fully opened position with the poppet moved away from the poppet orifice to allow hydraulic flow into the central chamber to build pressure within the central chamber;
equalizing the pressure in the central chamber to the compression boost valve chamber through the compression feed orifice and rebound boost valve chamber through the boost nut rebound feed orifice and the boost post rebound feed orifice, wherein the pressure in compression boost valve chamber and the rebound boost valve chamber is higher than downstream damper pressure as a result of pressure drops across the inlet orifice and the poppet orifice; and
generating a force acting against the rebound deflecting disc shim stack and the compression deflecting disc shim stack, wherein in the rebound boost valve generates high levels of hydraulic pressure across the main piston to restrict the flexing of the rebound deflecting disc shim stack and inhibiting hydraulic flow through rebound ports of the main piston until a pressure in the rebound ports reaches a pressure higher than the combined force of the rebound deflecting disc shim stack, the pressure of the rebound boost valve, and the force of the rebound boost valve spring allowing hydraulic flow to move through the rebound ports.

11. A compact dual boost valve system for a hydraulic damper comprising:
a piston assembly of the hydraulic damper, the piston assembly comprising:
a damper rod;
a boost post coupled to the damper rod on a first end of the boost post, the boost post comprising a central chamber extending along an axis of the boost post with an inlet orifice located a second end of the boost post and extending into the central chamber;
a main piston coupled around the boost post;
a compression deflecting disc shim stack coupled around the boost post on a compression side of the main piston for compression damping; and
a rebound deflecting disc shim stack coupled around the boost post on a rebound side of the main piston for rebound damping;
a pilot stage comprising a proportional pressure relief poppet valve coupled within a damper rod of the hydraulic damper, the poppet valve comprising:
a poppet coupled to an armature retained within a cartridge, the poppet and the armature guided by a bearing surface of the cartridge;
a poppet orifice located at the second end of the boost post and extending into the central chamber, wherein the poppet is biased against the poppet orifice by a poppet spring; and
a bobbin carrying a solenoid coil coupled around the cartridge, the solenoid coil operating between a zero-power state and a 100% power state, wherein a powered state above the zero-power state reduces an amount of force the poppet applies to the poppet orifice, wherein the reduction in the amount of force increases until sufficient power is applied to overcome a spring force of the poppet valve reaching the 100% power state;
a compression main stage comprising a compression damping boost valve assembly, the compression damping boost valve assembly comprising:
a compression boost valve coupled around the boost post on a compression side of a main piston of the hydraulic damper, wherein the compression boost valve is biased against the compression deflecting disc shim stack by a boost valve compression spring; and
a compression boost valve chamber coupled to the central chamber by a compression feed orifice; and
a rebound main stage comprising a rebound damping boost valve assembly, the rebound damping boost valve assembly comprising:
a rebound boost valve coupled around a boost nut, the boost nut coupled to the second end of the boost post, wherein the rebound boost valve is biased against the rebound deflecting disc shim stack by a boost valve rebound spring; and
a rebound boost valve chamber fluidly coupled to the central chamber by a boost nut rebound feed orifice extending through the boost nut that interfaces with a boost post rebound feed orifice extending from the central chamber, wherein during a compression event at the zero-power state:
the poppet is biased against the poppet orifice;
the poppet valve operates to equalize pressure in the compression boost valve chamber and the rebound boost valve chamber with an upstream damper pressure to generate high levels of hydraulic pressure across the main piston until a blow-off pressure of the poppet valve is reached; and
opening the poppet with the high levels of hydraulic pressure and generating a pressure drop across the inlet orifice and the poppet orifice in response to hydraulic flow through the poppet valve after the poppet valve opens.

12. The system of claim 11, wherein the boost nut coupled to the first end of the boost post operates to retain the rebound boost valve assembly, the main piston, the compression deflecting disc shim stack, the rebound deflecting disc shim stack and the compression boost valve assembly coupled around the boost post.

13. The system of claim 11, wherein the boost nut rebound feed orifice interfaces with the boost post rebound feed orifice at boost nut chamber, wherein the boost nut chamber allows for unrestricted rotation of components of the rebound boost valve assembly and axial flexibility to compensate for differences in the rebound deflecting disc shim stack tuning by providing a means of a fluid coupling between the boost nut rebound feed orifice and the boost post rebound feed orifice without the boost nut rebound feed orifice and the boost post rebound feed orifice being aligned.

14. The system of claim 11, wherein rod velocity, rod acceleration, electrical control signal to the solenoid coil of the poppet valve, and sizes of the inlet orifice and the poppet orifice determine the pressure communicated simultaneously to both the compression boost valve assembly and the rebound boost vale assembly through the central chamber.

15. The system of claim 11, wherein during a rebound event in the zero-power state:
the poppet valve moves to the closed position with the poppet biased against the poppet orifice; and
the central chamber pressure is equal to downstream damper pressure resulting in no increased pressurization of either the compression boost valve chamber or the rebound boost valve chamber, and no hydraulic pressure force generated against either the compression deflecting disc shim stack or the rebound deflecting disc shim stack.

16. The system of claim 11, wherein during a rebound event in the 100% power state:
the poppet valve moves to a fully opened position with the poppet moved away from the poppet orifice to allow hydraulic flow into the central chamber to build pressure within the central chamber;
equalizing the pressure in the central chamber to the compression boost valve chamber through the compression feed orifice and rebound boost valve chamber through the boost nut rebound feed orifice and the boost post rebound feed orifice, wherein the pressure in compression boost valve chamber and the rebound boost valve chamber is higher than downstream damper pressure as a result of pressure drops across the inlet orifice and the poppet orifice; and
generating a force acting against the rebound deflecting disc shim stack and the compression deflecting disc shim stack, wherein in the rebound boost valve generates high levels of hydraulic pressure across the main piston to restrict the flexing of the rebound deflecting disc shim stack and inhibiting hydraulic flow through rebound ports of the main piston until a pressure in the rebound ports reaches a pressure higher than the combined force of the rebound deflecting disc shim stack, the pressure of the rebound boost valve, and the force of the rebound boost valve spring allowing hydraulic flow to move through the rebound ports.

17. A method of boosting damping a hydraulic damper, the method comprising:
providing a compact dual boost valve system coupled to a piston assembly of the hydraulic damper, the compact dual boost valve system comprising:
a pilot stage comprising a proportional pressure relief poppet valve coupled within a damper rod of the hydraulic damper, the poppet valve comprising:
a poppet coupled to an armature retained within a cartridge, the poppet and the armature guided by a bearing surface of the cartridge;
a poppet orifice located at the second end of the boost post and extending into the central chamber, wherein the poppet is biased against a poppet orifice by a poppet spring; and
a bobbin carrying a solenoid coil coupled around the cartridge, the solenoid coil operating between a zero-power state and a 100% power state, wherein a powered state above the zero-power state reduces an amount of force the poppet applies to the poppet orifice, wherein the reduction in the amount of force increases until sufficient power is applied to overcome a spring force of the poppet valve reaching the 100% power state;
a compression main stage comprising a compression damping boost valve coupled on a compression side of a main piston of the hydraulic damper; and
a rebound main stage comprising a rebound damping boost valve coupled on a rebound side of a main piston of the hydraulic damper, the poppet valve in fluid communication with the compression damping boost valve assembly and the rebound damping boost valve assembly;
performing a compression event in the zero-powered state during operation of the hydraulic damper with the poppet biased against the poppet orifice;
equalizing pressure in the compression damping boost valve assembly and the rebound damping boost valve assembly with an upstream damper pressure in response to the poppet valve in the closed position to generate high levels of hydraulic pressure across the main piston until a blow-off pressure of the poppet valve is reached; and
opening the poppet valve with the high levels of hydraulic pressure and generating a pressure drop across an inlet orifice and the poppet orifice in response to hydraulic flow through the poppet valve after the poppet moves away from the poppet orifice.

18. The method of claim 17, further comprising performing during a rebound event in the zero-power state;
moving the poppet valve to the closed position with the poppet biased against the poppet orifice, wherein the central chamber pressure is equal to downstream damper pressure resulting in no increased pressurization of either the compression boost valve assembly or the rebound boost valve assembly.

19. The method of claim 17, further comprising a rebound event in the 100% power state;
moving the poppet valve to a fully opened position with the poppet moved away from the poppet orifice to allow hydraulic flow into the central chamber to build pressure within the central chamber in response current flowing through the solenoid coil;
equalizing the pressure in the central chamber to the compression boost valve chamber through the compression feed orifice and rebound boost valve chamber through the boost nut rebound feed orifice and the boost post rebound feed orifice, wherein the pressure in compression boost valve chamber and the rebound boost valve chamber is higher than downstream damper pressure as a result of pressure drops across the inlet orifice and the poppet orifice; and
generating a force acting against the rebound deflecting disc shim stack and the compression deflecting disc shim stack, wherein in the rebound boost valve generates high levels of hydraulic pressure across the main piston to restrict the flexing of the rebound deflecting disc shim stack and inhibiting hydraulic flow through rebound ports of the main piston until a pressure in the rebound ports reaches a pressure higher than the combined force of the rebound deflecting disc shim stack, the pressure of the rebound boost valve, and the force of the rebound boost valve spring allowing hydraulic flow to move through the rebound ports.
